(19) United States
(12) Patent Application Publication
(10) Pub. No.: US 2012/0325735 A1
(43) Pub. Date: Dec. 27, 2012

(54) WATER FILTER ASSEMBLY AND FILTER ELEMENT

(76) Inventors: Leon Milner Theodore Dicks, Stellenbosch (ZA); Marelize Botes, Stellenbosch (ZA); Danielle Marguerite Du Plessis, Somerset West (ZA); Thomas Eugene Cloete, Somerset West (ZA); Michelle De Kwaadsteniet, Stellenbosch (ZA); Nonjabulo Diamini, Somerset West (ZA)

(21) Appl. No.: 13/582,267

(22) PCT Filed: Feb. 22, 2011
(86) PCT No.: PCT/IB11/00346

§ 371 Date: Aug. 31, 2012

(30) Foreign Application Priority Data
Mar. 2, 2010 (ZA) 2010/01493
Sep. 2, 2010 (ZA) 2010/06285

(51) Int. Cl. B01D 24/10; B01D 29/13; B01D 29/00; B82Y 30/00; B82Y 99/00

(52) U.S. Cl. 210/289; 210/291; 210/435; 210/484; 977/700; 977/781

(57) ABSTRACT

A water filter assembly and water filter element are provided. The water filter element has water permeable barriers through which water is to be passed in use in order to purify same. The permeable barrier comprises a nanofibre layer defining nanopores which may be carried by a permeable support layer. The water filter element, in one form, includes an enclosure housing at least one of granular activated carbon, at least one appropriate ion exchange resin and at least one appropriate adsorbent. The nanofibers preferably have antimicrobial properties inherent thereto or provided by a biocidal agent trapped within the nanofibres or a layer thereof, or both. The water filter assembly has a perforated holder that operatively snugly receives the water filter element in a flow path through the water filter assembly. Preferably, the perforated holder has a screw threaded socket for attaching it to a container.

### FIELD OF THE INVENTION

This invention relates to a water filter assembly and filter element therefor whereby water can be purified to an extent that it is generally potable. More particularly, the invention relates to water filter assemblies and replaceable water filter elements therefor that are especially, although not exclusively, suitable for small scale use, particularly domestic or personal scale of use, for the purpose of producing potable water.

### BACKGROUND TO THE INVENTION

Various different forms of small-scale water filters, especially portable water filters, are available for use, in particular, by inhabitants of rural areas or visitors to rural areas as well as in disaster areas where potable water supplies have been disrupted or are simply not available. Not only are bacteria and other microorganisms [possibly including malaria protozoa] typically present in impure naturally occurring water, but, in many instances, pollution is also present in the form of man-made chemicals and waste as well as human and animal waste.

Most commonly used to purify small amounts of water are filter elements that include a filtration barrier and, commonly, a chlorine releasing compound and activated carbon contained in a filter bag or other container made of a filter material. Also commonly used are porous ceramic filters.

Some existing filter assemblies that are available, such as the so-called

“LIFESAVER™” water bottle, are rather expensive and beyond the means of many would-be users of the system.

Another problem with many prior art filter assemblies is that microorganisms filtered out may propagate on the filter surface and cause the formation of a biofilm thereby blinding the filter surface at least to some extent.

As a result of difficulties and costs of filtration equipment, chemical treatment of water is often employed. One commercially available biocide that is used for this purpose is one sold under the trade name AquaQure, which is a solution containing the following elements in order of decreasing concentration, Cu, Zn, K, Ca, Na, Fe, Mg, B, Cr, Cd, Sr, Ni and Si. This product is available from AquaQure Global Water Solutions of Swellendam, Western Cape Province, South Africa.

### OBJECT OF THE INVENTION

It is an object of this invention to provide a water filter assembly and filter elements for use therein that provide for effective water purification wherein at least one of the disadvantages mentioned above is obviated to some extent.

### SUMMARY OF THE INVENTION

In accordance with a first aspect of the invention there is provided a water filter element in the form of an enclosure having water permeable barriers through which water is to be passed in use in order to purify same with the interior of the enclosure housing at least one of granular activated carbon, at least one appropriate ion exchange resin and at least one appropriate adsorbent, the filter element being characterized in that the permeable barrier comprises a nanofibre layer defining nanopores through which water is to permeate in use.

In accordance with a second aspect of the invention there is provided a water filter element having a water permeable barrier through which water is to be passed in use in order to purify same, the water filter element being characterized in that the water permeable barrier comprises a permeable support layer and a nanofibre layer carried thereby wherein the nanofibre layer defines nanopores through which the water is to permeate in use.

Further features of the invention provide for the nanofibers to have antimicrobial properties that are either inherently a property of the nanofibres themselves and/or provided by a biocidal agent entrained or otherwise trapped within the nanofibres or a layer thereof; for any enclosure to be either of a generally cylindrical shape or of a generally flat rectangular or square shaped bag rolled up to a cylindrical shape in each instance with the cylindrical shape being adapted to fit closely into a perforated holder; for at least one granular or bead-like ion exchange resin or adsorbent, especially a cation exchange resin, to be included within the enclosure typically in admixture with granular activated carbon; and for any permeable support layer to be a speciality filter type of paper of the general type widely used for producing teabags and the like.

It is to be noted that the type of speciality filter paper, when selected correctly, may exhibit a highly beneficial characteristic in that, when used as a supporting matrix for nano fibers, the fibers become interwoven into the pores of the speciality paper thereby eliminating the necessity for any additional adhesion or bond enhancing expedients. The speciality filter paper may be of a type that has a rougher and a smoother side, and in that instance, the nano fibers are carried by the rougher side.

The nanopores defined by the nanofibre layer generally have sizes that are selected to retain microorganisms and other particles having a size greater than about 1 micron.

The invention also provides a water filter assembly comprising a water filter element as defined above together with a perforated holder therefor wherein the perforated holder snugly receives the water filter element in a flow path through the water filter assembly.

Further features of this aspect of the invention provide for the perforated holder to be configured to either operatively fit into a mouth of a water container such as a can or bottle, especially a plastic drinking water bottle in which instance the holder has formations whereby it fastens into an outlet thereof, especially a screw threaded outlet neck or the like, or for the perforated holder to be located in a housing adapted to fit onto a water supply outlet such as a tap; and, in the instance that the screw threaded socket is to be used for attaching the perforated holder inside the mouth of a bottle, for the screw threaded socket to be fitted with a closure for closing the flow path through the water filter assembly with the closure optionally being of a sports cap type.

In accordance with a third aspect of the invention there is provided a method of producing nano fibers exhibiting antimicrobial properties wherein the method comprises electro-spinning nano fibers from a solution of a suitable polymer material, the method being characterized in that a suitable biocidal agent is embodied in the solution prior to electro spinning such that it becomes incorporated in the nano fibers to provide them with, or enhance, their antimicrobial properties.

The nanofibres may themselves be antimicrobial in nature in which instance it is an optional addition to add a biocidal agent to become entrained within the nanofibre layer. Alternatively, the nano fibers themselves may not exhibit any antimicrobial properties in which instance it is regarded as generally essential to add the biocidal agent preparatory to electro-spinning.

The reason for providing the anti-microbial property is that microorganisms that are filtered out by the nanofibre layer are killed and therefore cannot multiply in a manner tending to promote biofilm formation. The nano fiber layer therefore does not exhibit a propensity to become unnecessarily blinded. The life of the resultant filter element is thus considerably extended when compared to an instance in which biofilm can form.

The biocidal agent could be the AquaQure mentioned above or it could be one or more appropriate furanones, or any other compatible biocide.

In order that the invention may be more fully understood a more detailed discussion and various examples follow with reference to the accompanying drawings.

### BRIEF DESCRIPTION OF THE DRAWINGS

In the drawings:—

FIG. 1 a schematic sectional elevation of a water drinking bottle fitted with a water filter assembly according to the invention;

FIG. 2 is a schematic sectional elevation of a tap fitted with a water filter assembly according to the invention

FIG. 3 is an isometric view of a filter element in the form of a water permeable bag;

FIG. 4 is an isometric view of the filter element in a rolled up format ready for insertion into a cylindrical perforated holder therefor;

FIG. 5 is an exploded isometric view of a holder for the filter element illustrated in FIGS. 1 and 2; and,

FIG. 6 is a sectional elevation of the holder assembly.

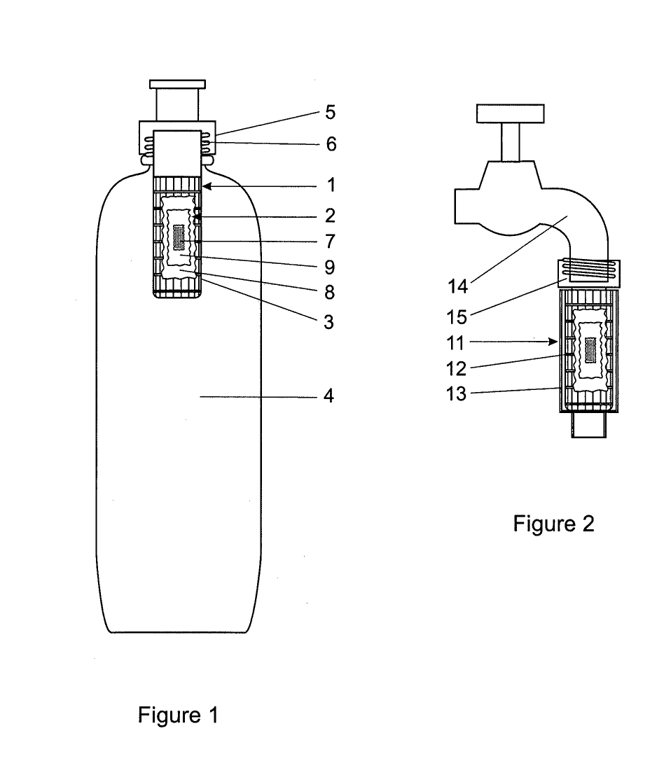

### DETAILED DESCRIPTION WITH REFERENCE TO THE DRAWINGS

In one embodiment of the invention a water filter element [1] is in the form of a water permeable bag [2] that defines an enclosure having water permeable barriers defining a pathway for water to pass through the filter element. The bag may be made from a speciality grade of paper of the type widely used for the production of teabags.

The filter element is made to be a close fit in a generally cylindrical perforated holder [3] that operatively fits into the mouth of a water container such as a can or bottle, especially a plastic drinking water bottle [4]. The holder thus has a screw threaded socket [5] for releasably fastening it onto a screw threaded outlet neck [6] of the bottle with the perforated walls of the holder projecting into the bottle so that the filter element forms the outlet passage from the bottle.

The bag houses granular activated carbon having a particle size of about 1 mm that is indicated by numeral [7] and that may be mixed with at least one granular or bead-like ion exchange resin also having a particle size of about 1 mm. In this instance a cation exchange resin was employed, although an anion exchange resin could be used in addition or alternatively, depending, at least to some extent, on the general characteristics of the water to be purified. Any other appropriate adsorbent may also be used by the in addition or instead of the granular activated carbon or ion exchange resin.

As provided by this invention, the filter element has a permeable barrier defined by the wall of the bag that comprises a permeable support layer defined by speciality paper [8] [teabag type of paper] and a nanofibre layer [9] carried thereby wherein the nanofiber layer defines nanopores through which water is to permeate in use.

The nanofiber layer is configured to provide nanopores that are dimensioned so as to prevent passage of microorganisms and other particles that render the water not potable.

In this embodiment of the invention the nanofibers are selected to have antimicrobial properties and, in particular, the nanofibers are electrospun from a PVA material that preferably has a biocidal agent entrained or otherwise trapped within the nanofibre layer.

### Test 1

Nanofibers were made using polyvinyl alcohol (PVA) and the biocide AquaQure in order to provide required antimicrobial properties.

The nanofiber layer of PVA was prepared as follows:—

Hydrolyzed (87-89%) poly(vinyl alcohol) (8.5% w/v) was dissolved in distilled water. A cross-linking agent, glyoxal, (8% v/v) (40% aqueous solution) was stirred into the PVA solution until dissolved and a drop of concentrated HCl was added to lower the pH to 2. AquaQure (5% v/v) was added to the solution and stirred.

For electrospinning, a bubble spinner was used in an environment with a relative humidity of <40%. The anode was submerged in the polymer solution and the cathode was attached to the collector plate. The collector plate was positioned directly above the bubble-spinning widget at a distance of 25 cm. The nano fibers formed were maintained at 60° C. for a period of four days in order to allow cross-linking to take place.

Filter bags were formed of the resultant speciality paper carrying the nanofibre layer and were filled with 4 g activated carbon and ion exchanger mix. The bags were heat sealed with the electrospun nanofibre layer on the inside to form the final filter elements.

The nanopores defined by the nanofibre layer have sizes that are selected to retain microorganisms and other particles having a size greater than about one micron.

Tests were conducted on nanofiber PVA that did not incorporate the biocide AquaQure and PVA that did incorporate AquaQure. The results are given below and show that the latter totally removed the stated microorganisms whilst only a small proportion was removed using the PVA that did not incorporate the biocide AquaQure.

| | Strain | |
|---|---|---|
| | Escherichia coli (Xen | Staphylococcus aureus |
| | 14) | (Xen 36) |
| Before filtering | 1.41 × 10⁹ | 1.72 × 10¹⁰ |
| After filtering with PVA | 1.30 × 10⁹ | 1.30 × 10¹⁰ |
| only fibres | | |
| After filtering with PVA | CLEAN | CLEAN |
| fibres incorporating | | |
| AquaQure | | |

It is therefore envisaged that the invention will provide an extremely simple yet highly effective and inexpensive water filter assembly and filter elements for use therein.

Of course, the water filter according to the invention can assume many different forms and it is envisaged that one other particularly useful form would be of the type illustrated in FIG. 2. In this form the water filter, generally indicated by numeral [11] has a holder [12] fitting into a housing [13] adapted to fit onto a water supply outlet tap [14] using the usual screw threaded socket [15]. In this form the water filter can be applied to a water tap by any user of the water as and when desired. Any sort of connector can be used to attach such a water filter to a tap, for example, depending on the configuration of the tap.

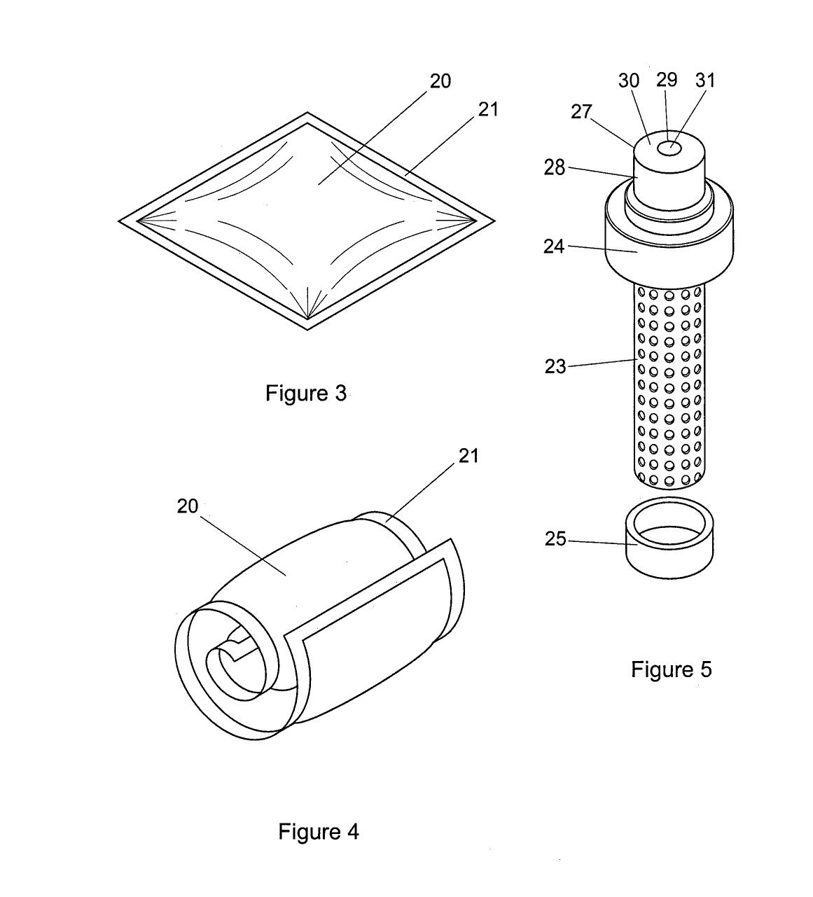

In another embodiment of the invention that is illustrated in FIGS. 3 to 6 of the accompanying drawings, a filter is produced as a generally flat rectangular or square bag [20] made of a speciality paper that is used for the production of tea bags and that is heat sealed, as indicated by numeral [21], around its periphery.

The speciality paper used in this instance is that sold under the trade name DYNAPORE tea filter paper by Glatfelter Gernsbach GmbH & Co. KG [Composite Fibers Business Unit] of Gernsbach, GERMANY, as their quality 117/S product. The paper had a weight of 16.50±1.00 g/m²; a thickness of 65.00±5.00 micron; and a heat-sealable surface.

The nano fiber layer is applied directly to the rougher of the two surfaces of the speciality paper by an electrospinning procedure the details of which are as follows. This method has the highly beneficial characteristic in that the nano fibers become interwoven into the pores of the speciality paper thereby eliminating the necessity for any additional adhesion or bond enhancing expedients.

### Test 2

Poly(vinyl alcohol) (PVA, Mr 146 000-186 000 Dalton, 87-89% hydrolysis) (8.5% w/v) was dissolved in distilled water and heated at 90° C. for 30 min while stirred. A cross-linking agent in the form of glyoxal, (8% v/v) (40% aqueous solution) was stirred into the PVA solution until dissolved and a drop of concentrated HCl was added to lower the pH to 2. It should be noted that the glyoxal concentration can be lowered and cured at a higher temperature for a shorter period of time. It should also be noted that PVA was used again simply for the reason that the PVA used is approved for use in relation to food and drugs.

This polymer solution was left to cool down and AquaQure (5% v/v) was added to the solution and stirred until it was dissolved.

The heat sealable speciality paper was cut into squares of 64×64 mm. The paper, with the rough side facing upwards, was attached to a tinfoil collector plate.

The polymer solution was injected into a Pasteur pipette and a copper wire, attached to the positive electrode of a high voltage power supply was inserted into the polymer solution. The negative electrode was attached to the tinfoil collector plate at a distance of 200 mm from the pipette. A high voltage was applied at a current of 15 kV and nanofibres were ejected towards the tinfoil collector plate and thus onto the speciality paper.

The paper was then removed and baked in an oven for 4 days at 60° C. The dry weight of the nanofibres was 600 g/m². The diameter of the nanofibres was between 200 and 350 nm, depending on the concentration of AquaQure and the voltage used. An applied voltage of 15 kV with a 5% PVA/AquaQure concentration gave rise to nanofibres having a diameter of about 250 nm. The sizes of the pores formed is between the nanofibres was from 7 and 13 nm²

Bags were then prepared by heat sealing the edges of the electrospun paper on top of each other whilst leaving one side open. Each bag was filled with 3 g granular activated carbon (AquaSorb® 1000, Jacobi Carbons AG, Rheinweg 5, 8200 Schaffhausen, Switzerland) and heat sealed in order to close it.

The filter bags, are dimensioned to be accommodated in a perforated cylindrical holder [23] that has an integral fitting [24] at one end and a removable cap [25] at the opposite end, as shown clearly in FIG. 3. The dimensions of the cylindrical holder are selected so that, when tightly rolled up, as illustrated in FIG. 4, a filter bag can be inserted into the cylindrical holder in which it becomes a snug fit. The removable cap is then replaced on the open end of the holder through which the rolled up filter bag was introduced.

The fitting has a screw threaded socket [26] for releasably fastening it onto a screw threaded outlet neck of a bottle with the perforated cylindrical holder [23] projecting into the bottle so that the filter element forms the outlet passage from the bottle.

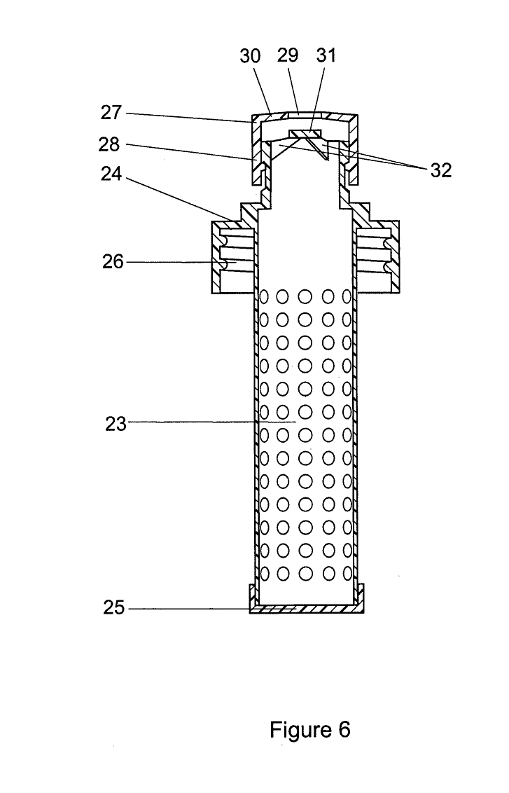

The fitting preferably has what is known as a sports cap outlet that embodies a valve comprising a closure teat [27] having an external skirt [28] that slides axially between a closed position and an open position. In the closed position an aperture [29] in an end wall [30] of the closure teat is occupied by a plug member [31] held centrally in the outlet passage by integral webs [32] of material attaching it to the inner wall of the fitting [24]. In the open position, the closure teat is axially displaced outwards [as illustrated in FIG. 6] so that water can flow through the outlet passage past the plug and through the aperture [29].

It will be understood that whilst the cylindrical holder and fitting are described above as being integral with each other, tools and dies for manufacturing such an integral plastics injection molding may not be practical and, in that instance, the cylindrical holder can be made as a separate unit that attaches to the fitting, preferably in a generally irreversible manner in order to substantially avoid use of the fitting without the holder in its operative position.

Other antimicrobial nanofibers that have been prepared are as follows:—

i. The Biocide Copper and the Polymer PVA

Poly(vinyl alcohol)/Copper (PVA/Cu) fibre mats were fabricated by mixing 10% w/v PVA and CuSO₄.5H₂O (5-15% w/v) in water at room temperature with continuous stirring until the salt was completely dissolved. Glyoxal (8%) was added as cross-linking agent and the nanofibres were cross linked by curing at 60° C. for 4 days.

ii. The Biocide Furanones and the Polymer PVA

Poly(vinyl alcohol)/furanones fibre mats were fabricated by mixing 8% w/v PVA and furanones (2-10% w/v) in water at room temperature with continuous stirring until the salt was completely dissolved. Glyoxal (8%) was added as cross-linking agent and cross linked by curing at 60° C. for 4 days.

iii. The Biocide Silver and the Polymer PVA

A polymer solution of 8 wt % PVA was prepared by dissolving PVA powder in water with gentle stirring at 90° C. The polymer solution was left to cool down and 8% v/v glyoxal was added as cross-linking agent and the pH was adjusted to 5 with concentrated HCl to aid the cross-linking process. Finally, 5% (wt/v) AgNO₃ was added to the polymer solution, and was thoroughly mixed. PVA nanofibers containing AgNO₃ were collected on the plate, and were cross linked by curing at 60° C. for 4 days. Subsequent to cross-linking, the nanofibers were exposed to UV irradiation for 1 hour to reduce silver ions in the nanofibers to silver nanoparticles.

iv. The Biocide Silver and the Polymer PAN (Polyacrylonitrile)

A polymer solution of 6% (wt/v) PAN in dimethyl formamide (DMF) (Sigma Aldrich) was prepared. DMF was heated up to 90° C. and stirred while PAN was added gradually. The mixture was stirred at 90° C. for 5 hours until a clear, dark yellow solution was obtained. Silicone surfactant, JSYK L580 (0.95 g/l) was added to stabilize bubble formation during bubble-electrospinning. Finally, 5% (wt/v) Ag NO₃ was added to the polymer solution and was mixed thoroughly. PAN nanofibers containing AgNO₃ and already reduced silver nanoparticles, were collected on the plate. Subsequently, the nanofibers were exposed to UV irradiation for 1 h to reduce any remaining silver ions in the nanofibers to silver nanoparticles.

Numerous variations may be made to the two different forms of the invention described above without departing from the scope hereof. In particular, the nature of the nano fiber layer can be varied widely and the permeable support can also be varied, as may be desired and appropriate. Also, the granular activated carbon or the ion exchange resin could be replaced completely, or in part, by any other appropriate absorbent such as zeolite or betonite.

1. A water filter element comprising:
an enclosure having water permeable barriers through which water is to be passed in use in order to purify same with the interior of the enclosure housing at least one of granular activated carbon, at least one appropriate ion exchange resin and at least one appropriate adsorbent, wherein the enclosure is in the form of a water permeable bag and the permeable barrier includes a nanofibre layer defining nanopores through which water is to permeate in use.

2. A water filter element comprising:
a water permeable barrier through which water is to be passed in use in order to purify same wherein the water permeable barrier comprises a permeable bag and a nanofibre layer carried thereby wherein the nanofibre layer defines nanopores through which water is to permeate in use.

3. A water filter element as claimed in claim 1 in which the nanofibers have antimicrobial properties that are either inherently a property of the nanofibres themselves or provided by a biocidal agent entrained or otherwise trapped within the nanofibres or a layer thereof, or both.

4. A water filter element as claimed in claim 1 in which the bag is of a generally cylindrical shape with the cylindrical shape being adapted to fit closely into a perforated holder.

5. A water filter element as claimed in claim 1 in which the bag is a generally flat rectangular or square shaped bag suitable for being rolled up to a cylindrical shape with the cylindrical shape being fitting closely into a perforated holder.

6. A water filter element as claimed in claim 1 in which at least one granular or bead-like ion exchange resin or adsorbent is included within the bag.

7. A water filter element as claimed in claim 6 in which the permeable bag is a speciality filter type of paper of the general type widely used for producing teabags and the like.

8. A water filter element as claimed in claim 7 in which the speciality filter paper is of a type that has a rougher and a smoother side and the nano fibers are carried by the rougher side.

9. A water filter element as claimed in claim 1 in which the nanopores have sizes that are selected to retain microorganisms and other particles having a size greater than about 1 micron.

10. A water filter assembly comprising a water filter element as claimed in claim 1 and having a perforated holder that operatively snugly receives the water filter element in a flow path through the water filter assembly.

11. A water filter assembly as claimed in claim 10 in which the perforated holder is provided with a screw threaded socket for attaching the perforated holder either inside the mouth of a container or to a screw threaded water tap.

12. A water filter assembly as claimed in claim 11 in which the screw threaded socket is fitted with a closure for closing the flow path through the water filter assembly with the closure.

13. A water container fitted with a water filter assembly as claimed in claim 12.

14. (canceled)
